(19) United States
(12) Patent Application Publication
(10) Pub. No.: US 2008/0299515 A1
(43) Pub. Date: Dec. 4, 2008

(54) Duncan transfer screw

(76) Inventor: Gary Allan Duncan, Dublin, OH (US)

Correspondence Address: Mr. Gary Allan Duncan, 8831 Locherbie Court, Dublin, OH, 43017, US

(21) Appl. No.: 11/807,377

(22) Filed: May 29, 2007

(51) Int. Cl. A61C 8/00

(52) U.S. Cl. 433/174

(57) ABSTRACT

The Duncan Transfer Screw will assist in the process that will allow a surgeon to place a final dental implant restoration immediately after surgery into a patient's mouth that will function in conjunction with the dental implant(s) placed in the mandible and/or maxilla bone(s). The Duncan Transfer Screw is used in the manufacturing of a surgical dental implant stent that will allow a surgeon to place a dental implant(s) perfectly parallel to other dental implant(s) as well as teeth. The Duncan Transfer Screw is used in the manufacturing of a surgical dental implant stent that will allow a surgeon to place dental implant(s) at a predetermined depth within the mandible and/or maxilla of a patient undergoing surgery.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE, A TABLE, OR A COMPUTER PROGRAM LISTING COMPACT DISK APPENDIX

Not Applicable

### BACKGROUND OF THE INVENTION

The Duncan Transfer Screw is placed into use during a sequence of steps for the manufacturing of a surgical dental implant stent and is suggested to be placed under Class 433, Dentistry, as this class is a specific class under the broader class of Surgery and includes methods directed to or including specific dental steps whereas the use of this device ultimately facilitates the replacement teeth. The Duncan Transfer Screw is suggested to be assigned the Subclass 25, Apparatus, whereas this device or subcombination thereof is for facilitating the replacement, treatment, or testing of either natural of artificial teeth noting that the above apparatus does not remain in the patient's mouth after treatment.

The Duncan Transfer Screw is placed into use during the second step in solving notable problems in the process of both favorably manufacturing a surgical dental implant stent in the dental lab as well as ultimately surgically placing dental implants in the patients mouth using the aforementioned stent. Because the Duncan Transfer Screw or anything to serve it's exact purpose has not previously been invented, currently dental implant stents in addition to any other means used by surgeons to place any number of dental implants in a patient's mouth are unable to be manufactured as to allow such surgeons to place a dental implant parallel to other implants or existing teeth on the arch of the mandible or maxilla of a patient undergoing surgery. When a dental implant analog is not placed parallel to other dental implant analogs, final restorations are much more difficult to manufacture and the longevity of a final restoration is shortened. Without the Duncan Transfer Screw and/or the process of its use, surgical dental implant stents are unable to be manufactured as to allow surgeons to place a dental implant at a predetermined depth decided upon by the surgeon or allow a dental lab technician to manufacture a surgical dental implant stent that can be used to fabricate the final dental implant restoration that will stay the patient's mouth. When surgeons have no means to accurately follow through with making a fissure to place a dental implant at a predetermined depth, such surgeons when making this fissure will pass through the bone of the mandible or maxilla and be required to find a new site as well as restore the damaged area causing additional time for a patient undergoing the procedure to heal and recover. Currently, surgical dental implant stents are not manufactured as to allow a surgeon to immediately place a final dental implant restoration.

### BRIEF SUMMARY OF THE INVENTION

The Duncan Transfer Screw is placed into use during the second step of manufacturing a surgical dental implant stent. The Duncan Transfer Screw is used by placing a specified threaded end of the screw into a previously placed (in a model made of standard dental lab material replicating a patient's mandible or maxilla) parallel dental implant analog with matching threads leaving the other end of the screw above the plane of the aforementioned model. The Duncan Implant Screw assists in allowing the ultimate manufacture of a dental implant stent that for the first time will allow surgeons to control the depth of placed dental implant(s), while also allowing such surgeons to place dental implant(s) parallel to other dental implant(s) or teeth and immediately place the final dental implant restoration in a patient's mouth that will function in conjunction with dental implants placed using the aforementioned surgical dental implant stent.

The Duncan Transfer Screw assists the manufacturing of the aforementioned surgical dental implant stent and allows a final restoration to be manufactured with more ease. The Duncan Transfer Screw assists the manufacturing of the aforementioned surgical dental implant stent and allows for dental implant to be placed parallel allowing for increased longevity of a final restoration. The Duncan Transfer Screw assists the manufacturing of the aforementioned surgical dental implant stent that also will serve as a guide to a surgeon allowing him or her to place a dental implant at a predetermined depth thus leaving no error for correct and desired dental implant placement.

### BRIEF DESCRIPTION OF THE SEVERAL VIEWS OF THE DRAWING

FIG. 1 is a front view perspective of the Duncan Transfer Screw;

FIG. 2 is a side view perspective of the Duncan Transfer Screw;

FIG. 3 is a sectional view perspective of the Duncan Transfer Screw.

### DETAILED DESCRIPTION OF THE INVENTION

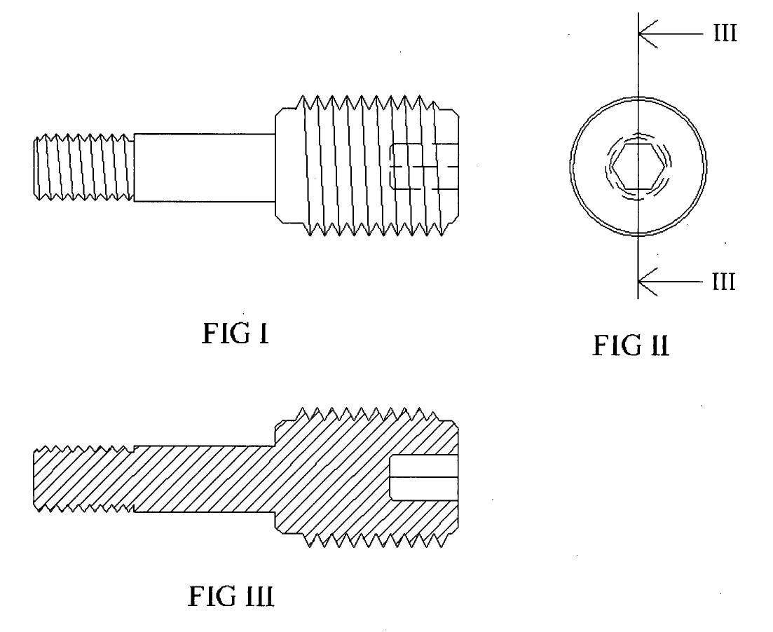

The Duncan Transfer Screw is best carried out while used in conjunction with a previously placed (in a model made of standard dental lab material which was itself made from impressions of a patients mandible or maxilla arch taken by a dentist replicating a patient's mandible or maxilla) parallel dental implant analog with mating threads. Referring to FIG. 1, the end with the smallest circumference relative to it's opposite, which contains external threads, is placed into the mating threads of a previously placed ( in the model replicating a patient's mandible or maxilla) and aforementioned dental implant analog by means of rotation. Also referring to FIG. 1, the end of the screw with a larger circumference relative to its opposite is machined as to have external threads as well and will serve as a mate to another step in the manufacturing of a surgical dental implant stent.

Referring to FIG. 2, the end of the screw with the larger circumference relative to its opposite is machined to have a void in it as to allow a screw driver like toot to be inserted into it to rotate the Duncan Transfer Screw into and out of a dental implant analog as well as the Duncan Transfer Band. Referring to FIG. 3, end of the screw with the larger circumference relative to its opposite is machined to be round in shape and have a void in it as to allow a screw driver like tool to be inserted into it to rotate the Duncan Transfer Screw into and out of a dental implant analog as well as the Duncan Transfer Band.

The Duncan Transfer Screw is the first of it's kind and is machined out of any surgical metal such as stainless steel or titanium while serving as the best way to carry out the manufacturing of this invention.

What is hereby claimed is:

1. The Duncan Transfer Screw is a device that with mating screw threads, will work in conjunction with a dental implant analog previously placed into any model made of standard dental lab material which replicates a patient's mandible or maxilla.

2. The device defined in claim 1 will allow for the easy transfer into and out of a dental implant analog.

3. The device defined in claim 1 will allow for the correct placement of the Duncan Transfer Band.

4. The device defined in claim 1 will allow for the easy transfer into and out of the Duncan Transfer Band.

5. The device defined in claim 1 can be machined to any desired dimension or dimensions desired.

6. The device defined in claim 1 can be machined as to mate or fit any manufactured tool or tools or apparatus for the purpose of rotating into and out of a dental implant analog.

7. The device defined in claim 1 can be machined out of any desired surgical metal

8. The device defined in claim 1 can be manufactured out of any material used for the purpose of this invention that is accepted by governing bodies of dental surgery and/or dental laboratories.

9. The device defined in claim 1 will allow for the manufacturing of a surgical dental implant stent that will allow a surgeon to place the final dental implant restoration immediately after surgery into a patient's mouth that will function in conjunction with the dental implant(s) placed in the mandible and/or maxilla bone(s) while using the aforementioned surgical dental implant stent.
